(19) United States
(12) Patent Application Publication
(10) Pub. No.: US 2025/0137414 A1
(43) Pub. Date: May 1, 2025

(54) PREDICTIVE CONTROL SYSTEM AND METHOD FOR VEHICLE SYSTEMS

(71) Applicant: CUMMINS INC., Columbus, IN (US)

(72) Inventors: Hoseinali Borhan, Bloomington, IN (US); Lisa A. Orth-Farrell, Columbus, IN (US)

(73) Assignee: CUMMINS INC., Columbus, IN (US)

(21) Appl. No.: 18/692,765

(22) PCT Filed: Sep. 20, 2022
(86) PCT No.: PCT/US2022/044145

§ 371 Date: Mar. 15, 2024

Related U.S. Application Data
(60) Provisional application No. 63/246,612, filed on Sep. 21, 2021.

(51) Int. Cl. F02D 41/14; B60W 20/11; B60W 50/00

(52) U.S. Cl. CPC F02D 41/1406; B60W 20/11; B60W 50/0097; B60W 2510/0623; B60W 2710/0644; B60W 2710/0666; B60W 2710/0677; F02D 2041/1412

(57) ABSTRACT

Systems and methods for using machine learning to improve control, management, and operation of vehicle systems are disclosed. A system includes a processing circuit configured to: receive information indicative of an observed state of a vehicle system from a sensor of the vehicle, the vehicle system including a fuel system; determine a predictive state of the vehicle system over a prediction horizon; determine one or more constraints for the vehicle system; execute a control problem to determine a predictive state of the vehicle system based on the one or more constraints; determine a plurality of control inputs for the vehicle system based on the executed control problem; and command the fuel system of the vehicle based on at least one of the determined plurality of control inputs.

### CROSS-REFERENCE TO RELATED APPLICATION

This application claims the benefit of and priority to U.S. Application No. 63/246,612, titled “PREDICTIVE CONTROL SYSTEM AND METHOD FOR VEHICLE SYSTEMS,” filed Sep. 21, 2021, which is incorporated herein by reference in its entirety.

### TECHNICAL FIELD

The present disclosure relates to control systems for vehicles. More particularly, the present disclosure relates to systems and methods for using machine learning to improve control, management, and operation of vehicle systems.

### BACKGROUND

Model predictive control is a strategy that may be used in digital controls for controlling a system. In operation, a computing system may include a model of a system that predicts future behavior of the system (e.g., a plant or another system subject to control) using historical data regarding operation of the system. Over time and through repeated execution of the model based on optimized inputs and received outputs regarding operation of the system, the model improves at predicting future behavior thus making the model more accurate at determining control inputs over time. However, model predictive controls are computationally intensive control schemes that make them difficult to implement in a variety of settings, such as mobile settings (e.g., vehicles).

### SUMMARY

One embodiment relates to a system including a processing circuit having one or more memory devices coupled to one or more processors. The one or more memory devices are configured to store instructions that, when executed by the one or more processors, cause the processing circuit to: receive information indicative of an observed state of a vehicle system of a vehicle from a sensor of the vehicle, the vehicle system including a fuel system; determine a predictive state of the vehicle system over a prediction horizon; determine one or more constraints for the vehicle system; execute a control problem to determine a predictive state of the vehicle system based on the one or more constraints for the vehicle system over the prediction horizon; determine a plurality of control inputs for the vehicle system based on the executed control problem; and command the fuel system of the vehicle based on at least one of the determined plurality of control inputs, the command structured to control at least one of a start of injection with at least one cylinder of an engine, a fuel flow rate, or a rail pressure for a common rail coupled to at least one fuel injector of the vehicle.

Another embodiment relates to an apparatus for a vehicle. The apparatus includes a processing circuit comprising one or more memory devices coupled to one or more processors, the one or more memory devices configured to store instructions that, when executed by the one or more processors, cause the processing circuit to: receive information indicative of an observed state of a vehicle system from a sensor of the vehicle; determine a predictive state of the vehicle system over a prediction horizon; determine one or more constraints for the vehicle system; execute a control problem to determine a predictive state of the vehicle system based on the one or more constraints for the vehicle system over the prediction horizon; determine a control input for the vehicle system based on the executed control problem; and command the vehicle system based on the determined control input.

According to some embodiments, the vehicle is a hybrid vehicle and the vehicle system includes an electric motor and an internal combustion engine. The control input defines a power split between the electric motor and the internal combustion engine.

In other embodiments, the vehicle system comprises a natural gas engine.

Still another embodiment relates to a method. The method includes: receiving, by one or more processors, information indicative of an observed state of a vehicle system of a vehicle from a sensor of the vehicle, the vehicle system including a fuel system; determining, by the one or more processors, a predictive state of the vehicle system over a prediction horizon; determining, by the one or more processors, one or more constraints for the vehicle system; executing, by the one or more processors, a control problem to determine a predictive state of the vehicle system based on the one or more constraints for the vehicle system over the prediction horizon; determining, by the one or more processors, a plurality of control inputs for the vehicle system based on the executed control problem; and commanding, by the one or more processors, the fuel system of the vehicle based on at least one of the determined plurality of control inputs, the command structured to control at least one of a start of injection with at least one cylinder of an engine, a fuel flow rate, or a rail pressure for a common rail coupled to at least one fuel injector of the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Additionally, one or more features of an aspect of the invention may be combined with one or more features of a different aspect of the invention.

### BRIEF DESCRIPTION OF THE FIGURES

FIG. 1 is a schematic view of a vehicle in an environment, according to an example embodiment.

FIG. 2 is a schematic view of the vehicle of FIG. 1, according to an example embodiment.

FIG. 3 is a flow diagram showing inputs to a controller (e.g., a cost function, constraints, and states) and outputs (control inputs) from the controller to a vehicle system, according to an example embodiment.

FIG. 4 is a more detailed view of the control inputs (e.g., actuator positions, engine speed, rail pressure, start of injection, etc.) and predicted output values from an air-handling model circuit and a cylinder and combustion model circuit of the controller of FIGS. 1-2, according to an example embodiment.

FIG. 5 is a flow chart of a method for determining the control inputs for the vehicle and, particularly one or more vehicle subsystems, of FIGS. 1-2, according to an example embodiment.

### DETAILED DESCRIPTION

Following below are more detailed descriptions of various concepts related to, and implementations of, methods, apparatuses, and systems for utilizing machine learning to tune, control, and operate systems and, particularly, vehicle systems. The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, the various embodiments disclosed herein relate to systems, apparatuses, and methods for utilizing machine learning, and more particularly model predictive control, in vehicle control systems. According to the present disclosure, a controller is included with a vehicle. The controller includes a processing circuit storing a control-oriented model and an optimizer circuit which together at least partly form/create a control scheme for controlling the vehicle. Upon execution by the controller, the control-oriented model utilizes an initial best guess model (based on previously observed states of the vehicle in response to implementing various control inputs) to predict future behavior of the vehicle system under examination (i.e., subject to control) and determine predictive outputs (i.e., predictive states) of the vehicle that are provided to the optimizer circuit. The optimizer circuit uses the predictive outputs and other constraints to solve or execute an optimal control problem in order to determine control inputs for the vehicle system. The control inputs may include, but are not limited to, a fuel injection quantity (IQ), a start of injection (SOI), a rail pressure (Pᵣₐᵢₗ), a charge flow (M_{chrg}), a fueling rate (Q_{fuel}), an exhaust gas recirculation flow (M_{egr}), and other inputs that may be controlled of the vehicle. Then, the controller implements these control inputs with the vehicle system. Once the controller has implemented the control inputs with the vehicle system, the controller receives, from one or more sensors, measurements or other information indicative of operation of the vehicle system based on the control inputs. For example, sensors may record, measure, determine, and/or otherwise observe the behavior of the vehicle system in response to the control inputs being implemented with the vehicle system, and provide to the controller observed states (outputs) of the vehicle system. The states generally refer to outputs/responses of vehicle components based on the control inputs. The states may include, but are not limited to, an exhaust manifold pressure (P_{EM}), an intake manifold pressure (P_{IM}), a turbine speed (ω_{T}), an intake manifold temperature (T_{IM}), an exhaust manifold temperature (T_{EM}), engine speed and torque, emission rates (e.g., particulate matter emissions rate (PM) and NOx emissions rate (NOₓ), and so on. Relative to the control inputs, the “states” refer to measured or determined operating characteristics of the vehicle/vehicle system(s) that result from the control inputs. For example, a “state” may be an intake manifold temperature and the intake manifold temperature may be a measured value (e.g., based on a measurement from an intake manifold temperature sensor) or a determined value (e.g., based on data that is used in a model or algorithm to estimate the temperature). Thus, the “states” as described herein may be measured or determined. In some embodiments, the controller may more immediately compare the predicted states of the vehicle/vehicle system relative to one or more pre-determined thresholds and adjust the control inputs accordingly before they are implemented. Based on implementation of the control inputs, the observed states are then analyzed by the controller (for example, via a comparison to a defined goal or a stored database of results) to determine how well the control-oriented model predicted the future behavior of the vehicle system(s). In other words, the predicted states may be compared to the observed states to determine the accuracy of the model. The controller updates the control-oriented model based on the vehicle system's observed states (e.g., outputs indicative of vehicle performance), or a portion thereof, so that the model trends toward desirable results (e.g., more accurately predicting the states of a vehicle) over time. Once the control-oriented model is updated, the process repeats and continues to repeat throughout the duration of vehicle operation (or another defined duration of operation). In this regard and in subsequent iterations, the predicted outputs are closer to the observed/actual states, such that the control inputs become optimized/improved over time at controlling the vehicle system(s) subject to one or more constraints or goals (e.g., the set of determined control inputs yield fairly accurate predicted results such that overall vehicle system operation is more predictable and, in turn, improved). The predictive control strategy employed by the controller allows the vehicle system to update the control-oriented model based on received real world results. In this way, initial tuning can be improved and ongoing system control can account for changing operating conditions of components within the vehicle system.

The control-oriented model within the controller may utilize supervised learning methods such as Support Vector Machine (SVM), Logistic Regression (LR), system identification and time series methods, Neural Networks, Deep Neural Networks, etc. Additionally, the control-oriented model can be changed using optimization or deep learning methods (e.g., dynamic programming, iterative logarithmic-quadratic proximal (LQP), quadratic proximal (QP), recency policy gradient, Q-learning, etc.

Technically and beneficially, the controller utilizes an adaptive and predictive model to develop controls for a vehicle's system(s) and components, such as an exhaust aftertreatment system and/or other vehicle systems and/or components. Typical calibration techniques utilized currently rely on a human calibrating and optimizing system operation offline, and plugging the determined values into an engine control module (ECM) or other electronic control unit or module (ECU/ECM) for system operation. These techniques utilize data collected in a controlled environment and include post processing of the collected data for calibration and/or optimization. However, real world operating conditions can be different from the conditions experienced during the controlled environment. For example, operating conditions can change significantly over time as components and vehicle systems age and/or environment conditions experienced during calibration may differ from environment conditions experienced during operation. Predictive model control processes within the controller described herein utilize online and real-time optimization with data collected in real world conditions to calibrate and optimize the control strategy, which adapts to changes in operating conditions without or substantially without a need to re-calibrate manually.

Additionally, the described model predictive control herein facilitates controlling a vehicle system subject to one or more vehicle system based constraints. For example, a vehicle system may have constraints related to engine torque or actuator positions (i.e., maximum allowed engine torque, maximum allowed actuator positions, etc.). The model predictive control strategy of the controller factors in these constraints when determining control inputs for the vehicle system. Typically, model predictive control strategies require lots of computing power but by employing one or more constraints, the model predictive control employed by the controller of the instant disclosure lessens the required computing power thereby enabling implementation of the controller onboard mobile settings/environments (e.g., a vehicle). In other words, the disclosed and described model predictive control with one or more constraints makes a normally difficult control scheme feasible to implement within a vehicle controller.

As described herein, the controller utilizes the model predictive controls to improve the accuracy and performance of the vehicle and/or vehicle system (e.g., reducing emissions, maximizing fuel efficiency, etc.). As a specific example, the iterative tuning of the control-oriented model allows the controller to learn how look ahead information, such as upcoming road grade (e.g., inclines and declines), affect vehicle speed control through actuation of a transmission, a fuel system, and/or an air handling system. For example, the controller may learn that less fuel is required when a decline is upcoming within a predetermined distance. Another example includes a determination by the controller of a certain altitude of operation and, subsequently, controlling the engine specific to the certain altitude to provide an improved fuel efficiency and/or emissions output relative to typically experienced fuel economies. These and other features and benefits are described more fully herein below.

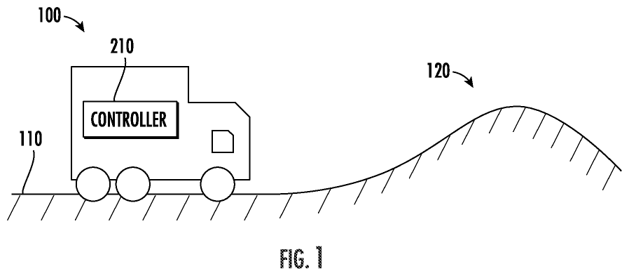

Referring now to FIG. 1, a vehicle 100 on a roadway 110 that includes terrain 120 (e.g., an incline, a decline, turns, rough patches of roadway, etc.) is shown, according to an example embodiment. The vehicle 100 can include a prime mover. The prime mover may be an internal combustion engine. The internal combustion engine may be powered by any one or more of a variety of fuels, such as a diesel fuel, gasoline, and/or natural gas. In this regard, the internal combustion engine may be a spark-ignited engine or a compression-ignition engine. In other embodiments, the vehicle 100 may include an at least partially electrified powertrain and, as such, be configured as a hybrid engine system including a motor (and/or a motor with generating capabilities such as a motor-generator) or a full electric system that only includes electric motors and no internal combustion engine. The vehicle may further include a drivetrain, an exhaust aftertreatment system, a controller 210 and other vehicle systems. The vehicle may be any type of on-road or off-road vehicle including, but not limited to, road sweeper vehicles, road sprinkler vehicles, refuse transfer vehicles, wheel-loaders, fork-lift trucks, line-haul trucks, mid-range trucks (e.g., pick-up truck, etc.), sedans, coupes, tanks, airplanes, boats, and any other type of vehicle.

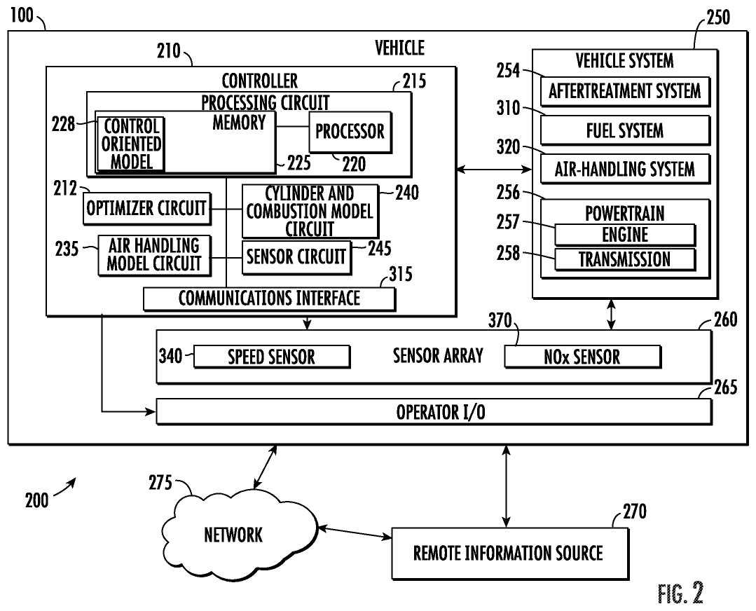

Referring now to FIG. 2, a schematic diagram of the vehicle 100 of FIG. 1 is shown, according to a more detailed view and example embodiment. As shown in FIG. 2, the vehicle 100 includes a controller 210, a vehicle system 250, a sensor array 260, and an operator input/output (I/O) device 265. Vehicle 100 is also communicably coupled to a remote information source 270 via a network 275. As described herein, the controller 210 is configured to control the vehicle using a model predictive control strategy/scheme.

The network 275 may be any type of network that facilitates and enables the exchange of information between and among the vehicle 100 and the remote information source 270. In this regard, the network 275 may communicably couple the vehicle 100 with the remote information source 270. In one embodiment, the network 275 may be configured as a wireless network. In this regard, the vehicle 100 may wirelessly transmit and receive data from the remote information source 270. The wireless network may be any type of wireless network, such as Wi-Fi, WiMax, Geographical Information System (GIS), Internet, Radio, Bluetooth, Zigbee, satellite, radio, Cellular, Global System for Mobile Communications (GSM), General Packet Radio Service (GPRS), Long Term Evolution (LTE), light signaling, etc. In an alternate embodiment, the network 275 may be configured as a wired network or a combination of wired and wireless protocols. For example, the controller 210 of the vehicle 100 may operatively couple via fiber optic cable to the network 275 to selectively transmit and receive data wirelessly to and from the remote information source 270.

The vehicle 100 includes a sensor array 260 that includes a plurality of sensors. The sensors are coupled to the controller 210, such that the controller 210 can monitor and acquire data indicative of operation of the vehicle 100. In this regard, the sensor array may include one or more temperature sensors. The temperature sensors acquire data indicative of or, if virtual, determine an approximate temperature of various components or systems, such as the exhaust gas at or approximately at their disposed location. The sensor array 260 may also include NOx sensors 370 (or sensors for other emissions) that acquire data indicative of or, if virtual, determine an approximate amount of NOx (or other exhaust gas constituent emissions) in the exhaust gas stream at or approximately at their disposed locations (e.g., immediately downstream of the engine 257, immediately downstream of the aftertreatment system 254, etc.). The speed sensor 340 is configured to provide a speed signal to the controller 210 indicative of a vehicle speed. In some embodiments, there may be a sensor that provides a speed of the vehicle (e.g., miles-per-hour) while in other embodiments the speed of the vehicle may be determined by other sensed or determined operating parameters of the vehicle (e.g., engine speed in revolutions-per-minute may be correlated to vehicle speed using one or more formulas, a look-up table, etc.). The NOx sensor 370 is configured to provide a NOx signal to the controller 210 indicative of an exhaust gas NOx output level (which may be expressed as a rate). Furthermore, the sensor array 260 may include a flow rate sensor that is structured to acquire data or information indicative of flow rate of a gas or liquid through a vehicle system 250 (e.g., exhaust gas through an aftertreatment system or fuel flow rate through an engine, exhaust gas recirculation flow at a particular location, a charge flow rate at a particular location, an oil or hydraulic flow rate at a particular location, etc.). The flow rate sensor(s) may be coupled to an aftertreatment system of the vehicle 100 and/or elsewhere in the vehicle 100. In this regard, other different/additional sensors may also be included with the vehicle 100, such as an accelerator pedal position (APP) sensor, a pressure sensor, an engine speed sensor (e.g., revolutions-per-minute), an engine torque sensor, a battery sensor, etc. Those of ordinary skill in the art will appreciate and recognize the high configurability of the sensors and their associated positions in the vehicle 100.

The vehicle 100 includes an operator input/output (I/O) device 265. The operator I/O device 265 may be communicably coupled to the controller 210, such that information may be exchanged between the controller 210 and the I/O device 265, where the information may relate to one or more components of FIGS. 1-3 or determinations (described below) of the controller 210. The operator I/O device 265 enables an operator of the vehicle 100 to communicate with the controller 210 and one or more components of the vehicle 100 of FIG. 1. For example, the operator input/output device 265 may include, but is not limited to, an interactive display, a touchscreen device, one or more buttons and switches, voice command receivers, etc. In this way, the operator input/output device 265 may provide one or more indications or notifications to an operator, such as a malfunction indicator lamp (MIL), etc. Additionally, the vehicle 100 may include a port that enables the controller 210 to connect or couple to a scan tool so that fault codes and other information regarding the vehicle may be obtained.

In the example depicted, the vehicle 100 is communicably coupled to a remote information source 270 over the network 275. The remote information source 270 is configured to provide information to the vehicle 100 and receive information from the vehicle 100. The remote information source may be a computing system or device that includes one or more processing circuits, network interfaces, and other computing systems and devices that couple to the network 275 and enables the exchange of information between the remote information source and the controller 210. Thus, the remote information 270 may be a source of information that is remote from the vehicle 100 and include one or more of another vehicle, a remote server/computing system (e.g., a fleet operator and its computing system), a mobile computing device (e.g., mobile phone, tablet computer, desktop computer, etc.). Thus, the controller 210 may form a V-2-X relationship with the remote information sources 270, where “X” can be another vehicle, a remote server, etc.

The remote information source 270 may provide external static information, where external static information refers to information or data that may vary as a function of position (e.g., the curvature or grade of the road may vary along a route) relative the vehicle 100 but is substantially unchanging with respect to time. For example, an external static information source may be a road grade database. The remote information source 270 may also provide external dynamic information. External dynamic information refers to information or data that may vary as a function of time (e.g., weather conditions, traffic conditions, etc.). Accordingly and in some embodiments, the controller 210 may receive look ahead information from the remote information source 270. “Look ahead” information refers to information/data regarding conditions that may affect operation of the vehicle “ahead” or in front of the vehicle (i.e., upcoming) and, in turn, may include external static and/or dynamic information. Accordingly, the controller 210 may determine or receive upcoming static and/or dynamic look ahead information in addition to existing operating information of the vehicle. In other embodiments, certain look ahead information (e.g., external static information such as maps, road grade, etc.) may be pre-programmed within the controller 210 such that the controller does not need to communicate with one or more remote information sources 270 to obtain this information.

Accordingly, the remote information source 270 may be any information provider capable of providing information to the vehicle 100. The remote information source 270 may be communicably coupled to the network 275 and provide information to the vehicle 100 through the network 100.

In some embodiments, the controller 210 may receive look ahead information via a telematics unit onboard the vehicle 100. In this regard and in one embodiment, the controller 210 may be capable of V2X communications via the telematics unit. V2X signifies the ability to exchange communications with the vehicle and another entity, such as other vehicles (V2V), a remote computing source (e.g., a cloud computing system), an infrastructure (V2I), and so on. The telematics unit may include, but is not limited to, a location positioning system (e.g., global positioning system) to track the location of the vehicle (e.g., latitude and longitude data, elevation data, etc.), one or more memory devices for storing the tracked data, one or more electronic processing units for processing the tracked data, and a communications interface for facilitating the exchange of data between the telematics unit and one or more remote devices (e.g., a provider/manufacturer of the telematics device, etc.). In this regard, the communications interface may be configured as any type of mobile communications interface or protocol including, but not limited to, Wi-Fi, WiMax, Internet, Radio, Bluetooth, Zigbee, satellite, radio, Cellular, GSM, GPRS, LTE, and the like. The telematics unit may also include a communications interface for communicating with the controller 210 of the vehicle 100. The communication interface for communicating with the controller 210 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data between the controller 210 and the telematics unit. In other embodiments, a local area network (LAN), a wide area network (WAN), or an external computer (for example, through the Internet using an Internet Service Provider) may provide, facilitate, and support communication between the telematics unit and the controller 210. In still another embodiment, the communication between the telematics unit and the controller is via the unified diagnostic services (UDS) protocol. All such variations are intended to fall within the spirit and scope of the present disclosure.

In some embodiments, the controller 210 may be configured for V2X communications without the usage of a telematics unit. For example, the controller 210 may be structured to receive information from the remote information source 270 over a wide area network communicating directly with the vehicle 100. In either configuration (with or without a telematics unit), the controller 210 may receive external static and/or dynamic information. Additionally and as described herein, the controller 210 may receive information to update or otherwise manipulate the control-oriented model 228 of the controller 210. Thus, the controller 210 may obtain this information from the remote information source to which the controller 210 is communicably coupled over the network 275. For example, the remote information source 270 may dynamically provide one or more constraints for the control-oriented model based on a dynamic location of the vehicle 100 to optimize emissions specific to the local regulations in place for the vehicle 100 based on the location of the vehicle. Beneficially, the constraints employed in the control-oriented model may change as a function of location of the vehicle 100 and be dynamically updated by the remote information source 270. Alternatively, the constraints may be preprogrammed in the controller 210 and be retrieved by the controller 210 automatically based on a location of the vehicle without communicating with the remote information source 270. The former configuration has the benefit of reducing on-board storage in the controller.

Still referring to FIG. 2, the powertrain system 256 of the vehicle 100 includes an engine 257 coupled to a transmission 258 (among potentially other components). The transmission 258 may be operatively coupled to a drive shaft which is operatively coupled to a differential, where the differential transfers power output from the engine 257 to the final drive (e.g., the wheels of the vehicle 100, tracks for some off-road applications) to help propel the vehicle 100.

In some embodiments, vehicle 100 may be a fuel cell electric vehicle (FCEV) which may include a fuel cell that provides power to at least one of a battery of the vehicle and/or an electric motor(s) of the vehicle. In this regard, the fuel cell powertrain system may include a battery structured to store electrical energy produced by the fuel cell. In this case, the controller 210 may utilize the control-oriented model and optimizer to develop a model predictive control scheme for controlling the energy management within the vehicle including but not limited to: controlling the charging of at least one of the fuel cell or the battery, controlling the diversion of energy from the fuel cell to a battery and/or electric motor, determining the power split between a fuel cell and a battery relative to a vehicle load or other vehicle operating condition, etc. The battery may be charged via regenerative braking (or another method) and/or from the fuel cell. In operation, typically a fuel cell vehicle powertrain system utilizes energy from the fuel cell during a high power load demand and utilizes energy from the battery during a low power load demand because a fuel cell may be less efficient during low power load demands. The controller 210 may use the control-oriented model described herein to manage the power split/usage from the fuel cell and battery(ies) during various load conditions to optimize energy management with the fuel cell vehicle given the strengths of the power sources (battery and fuel cell).

In some embodiments, the vehicle 100 may be an at least partially autonomous vehicle which implements an autonomous driving system such as an autonomous driver assistance system (ADAS) or an autonomous driving system (ADS). In some embodiments, the autonomous vehicle may include a connectivity enabled data which may be received via a telematics unit onboard the vehicle 100. The connectivity enabled data may include look-ahead information, information received from other vehicles and/or a remote computing system (e.g., V2V or V2X), and so on that is used with the control-oriented model described herein. In some embodiments, the ADAS/ADS may control various functionalities of the vehicle 100. In this way and consistent with SAE J3016, there may be multiple levels of automation. Depending on the configuration, the ADAS/ADS may enable up to a highest level of automation, which enables full automated driving. The lowest level of automation may provide for no driving automation. Between the highest and lowest levels of automation, there may be one or more intermediary levels of automation which may provide for some level of driver assistance, partial driving automation, conditional driving automation, high driving automation, etc.

The look-ahead information may be used by the controller 210 to control the vehicle, such as a speed of the at least partially autonomous vehicle. The look-ahead information may include any type of data or information that is ahead of the vehicle, which may include static or dynamic look-ahead information (static indicates that the information does not change with time, such as road grade data, while dynamic indicates that the information may change with time, such as traffic conditions). The look-ahead information may include road grade information, route curvature information, placement and type of road signage, weather conditions, traffic conditions, and so on. As an example, the autonomous driving system may continually determine and implement a speed target for the autonomous vehicle to control the speed of the at least partially autonomous vehicle. In this way, the controller 210 may optimize a speed target of the vehicle in addition to determining an implementing various control inputs (e.g., Q_{fuel}, Pᵣₐᵢₗ, u_{AHact}, SOI, M_{chrg}, M_{egr}). In this way and as described herein, the controller of the autonomous vehicle may utilize a control-oriented model to determine a speed target for the vehicle. The control oriented model may determine control inputs for the powertrain and a speed target simultaneously to autonomously control the speed of the vehicle.

In some embodiments and as alluded to above, the powertrain system may include an electric motor (not shown) and/or electric motor-generator (not shown) structured to generate and provide electrical energy to one or more vehicle accessories (hence, generator) as well as at least partly propel the vehicle. In some embodiments, the motor generator may be operably coupled to the engine 257 and the transmission 258 such that, in these embodiments, the vehicle 100 is structured as a hybrid vehicle (e.g., a combination of an internal combustion engine and an electric motor or motor/generator). The powertrain system 256 may further include a clutch or a torque converter configured to transfer the rotating power from the engine 257 and/or the motor generator to the transmission 258. In some embodiments, the clutch is located between the engine 257 and the motor generator. In some embodiments, the motor generator may receive power from an energy source, such as a battery that provides an input energy to output usable work or energy to in some instances propel the vehicle 100 alone or in combination with the engine 257. In other embodiments, energy may be diverted from the leaving the battery to power the vehicle back into the battery to charge the battery or any electrical powered accessories within the vehicle. The battery may be charged through regenerative braking, a fuel cell, or a combination of both.

Although referred to as a “motor generator” herein, thus implying its ability to operate as both a motor and a generator, it is contemplated that the motor generator component, in some embodiments, may be an electric generator separate from the electric motor (i.e., two separate components) or just an electric motor. Further, the number of electric motors or motor generators may vary in different configurations. The principles and features described herein are also applicable to these other configurations. Among other features, the motor generator may include a torque assist feature, a regenerative braking energy capture ability, and a power generation ability (i.e., the generator aspect). In this regard, the motor generator may generate a power output and drive the vehicle 100. The motor generator may include power conditioning devices such as an inverter and a motor controller, where the motor controller may be coupled to the controller 210. In other embodiments, the motor controller may be included with the controller 210.

As alluded to above, the controller 210 may be implemented with a hybrid vehicle in which the power demand required to power the vehicle may be split between an internal combustion engine and an electrical machine (e.g., a motor generator). More specifically, the controller 210 may determine and optimize a power split between the motor generator and the internal combustion engine using the control oriented model and optimizer circuit described herein. The controller 210 may optimize the power split between the internal combustion engine and the motor generator by analyzing vehicle information such as look ahead information, a battery state of charge, a fuel level, etc. in order to determine a desired power split between the internal combustion engine and the motor generator, which may be subject to one or more constraints (e.g., a maximum power output from the electric machine relative to that from the internal combustion engine that defines a power output capability from electric machine relative to the engine, a minimum state of charge of a battery(ies) needed to power the electric machine or enable a certain power output for a certain amount of time from the electric machine, etc.).

For example, the controller 210 may determine that the vehicle is approaching an uphill road grade followed by a downhill road grade based on look ahead information. The controller 210 may have also receive a goal to favor fuel economy over power output (or vehicle speed output). The controller may also receive an input that the speed limit is X MPH. Based on traditional vehicle usage, the controller 210 has determined that the operator likes to typically go X+7 MPH and, in turn, sets this speed as the desired vehicle speed (which may be correlated to the vehicle power output). In this case, the controller 210 may determine that when traversing the uphill road grade, the internal combustion engine provides relatively more power output from the internal combustion engine than from the motor generator to maintain this speed (e.g., 90% versus 10%). However, when the vehicle has completed traversing the uphill and begins to traverse the downhill grade, the controller 210 may determine that less power is needed from the internal combustion engine to maintain this speed range during the downhill and, in turn, adjusts the power split in favor of the electric machine (e.g., 20% of the total power from the internal combustion engine versus 80% from the motor generator). Using the control oriented model, the controller 210 may predict/determine power splits for various operating conditions along with predicted vehicle system states. Over time and subject to the constraints and goals of the control oriented model, the controller 210 determines optimized control inputs (e.g., a power split ratio) based on the received information and subject to the constraints and goals to improve vehicle operation over time. Over time and as the states are predicted with relatively more accuracy, the controller 210 determines associated control inputs that yield these relatively more accurate states. As such, the control inputs may be determined over time by the controller 210 to better coincide with desired vehicle operation characteristics (e.g., less reliance on the internal combustion engine and more on the electric machine(s) to reduce fuel consumption, etc.).

As another example, the controller 210 may be implemented with a range extended electric vehicle (REEV). The controller 210 receives look ahead information (e.g., information or data in front of the vehicle, such as an upcoming road grade). In one embodiment, the look ahead information indicates that an uphill portion of a route is upcoming. The controller 210 may then use the control oriented model to charge the battery(ies) in advance of the uphill portion to provide a maximum or substantially maximum power assist during the uphill operation of the vehicle. In another embodiment, the look ahead information indicates than a downhill portion of the route is upcoming. The controller 210 may then use discharge the battery(ies) earlier than normal in order to recharge the battery(ies) during the downhill portion using gravity (e.g., via regenerative braking). As another example, the look ahead information may indicate traffic with noise limits and/or emissions limits. The controller 210 may determine a geofence area associated with these area and then charge the battery(ies) to be able to operate in an electric vehicle mode in advance of entering the geofence area in order to limit engine noise, emissions, etc. As yet another example, the look ahead information may include weather information indicating that relatively cold temperatures (e.g., below a predefined cold temperature threshold). The controller 210 may warmup the battery(ies) for the upcoming low temperature operation to mitigate sometimes adverse operating affects associated with batteries in cold weather.

As alluded to above, the engine 257 may be any type of engine, such as a gasoline, natural gas, or diesel engine, and/or any other suitable engine. The engine 257 includes one or more cylinders and associated pistons. In the example shown, the engine 257 is structured as a compression-ignition engine that utilizes diesel fuel. Air from the atmosphere is combined with fuel, and combusted, to produce power for the vehicle. Combustion of the fuel and air in the compression chambers of the engine 257 produces exhaust gas that is operatively vented to an exhaust pipe and to the exhaust aftertreatment system.

The transmission 258 receives power from the engine 257 in the form of rotating crankshaft and provides rotational power to a final drive (e.g., the wheels of the vehicle 100) of the vehicle 100. In some embodiments, the transmission 258 is a continuously variable transmission (CVT). In other embodiments, the transmission 258 is a geared transmission comprising a plurality of gears. The transmission 258 may be an automatic, manual, automatic manual, etc. type of transmission. The transmission 258 may include one or more sensors (virtual or real) that couple to the controller 210 and provide information or data regarding operation of the transmission 258 (e.g., the current gear or operating mode, a temperature in the transmission box, etc.). The controller 210 is configured to control operation of the transmission 258, such as initiating transmission shift events and/or prompting an operator to initiate a shift event.

The vehicle system 250 may also include an exhaust aftertreatment system 254 having components or systems used to reduce certain exhaust gas constituent emissions, such as selective catalytic reduction (SCR) catalyst, a diesel oxidation catalyst (DOC), a diesel particulate filter (DPF), a diesel exhaust fluid (DEF) doser with a supply of diesel exhaust fluid, a plurality of sensors for monitoring the aftertreatment system (e.g., a nitrogen oxide (NOx) sensor, temperature sensors, flow rate sensors, etc.), and/or still other components. In operation, the controller 210 may be configured to determine and provide control inputs to the aftertreatment system 254 that affect (e.g., reduce or minimize) emissions, such as NOx emissions and particulate matter emission. As will be explained below in more detail, the controller may determine the control inputs to the aftertreatment system 254 by solving/executing an optimal control problem subject to one or more constraints with the goal of minimizing emissions of one or more exhaust gas constituents (e.g., greenhouse gases, CO, NOx, particulate matter, etc.). In turn, the controller 210 may control a doser to meter or otherwise control an amount of reductant inserted into the aftertreatment system or another action that affects the aftertreatment system's ability to reduce emissions of certain exhaust gas constituents.

The vehicle system 250 is further shown to include a fuel system 310 and an air handling system 320, in addition to the aftertreatment system 254 and powertrain 256. The fuel system 310 may include a fuel pump, one or more fuel lines (or a common rail system), and one or more fuel injectors that supply fuel or one or more cylinders from a fuel source (e.g., fuel tank). In some embodiments, the fuel system is a fumigated fuel system (e.g., injecting gaseous fuel into the intake air stream). In this case, the fuel entry point for the gaseous fuel is before an intake manifold and the fuel not injected directly into the cylinder of an engine. In one embodiment, fuel may be suctioned from the fuel source by the fuel pump and fed to the common rail system, which distributes fuel to the fuel injectors for each cylinder. Fuel can be pressurized to control the pressure of the fuel delivered to the cylinders. Thus, the controller 210 may control a fuel pressure in the common rail that in turn controls the fuel pressure fed to the fuel injectors. The air handling system 320 may include a turbo charger, an exhaust gas recirculation (EGR) system, and other components or systems that affect air management in the vehicle (e.g., intake air throttle valve, EGR valve, wastegate valve, etc.). The turbo charger may be or include a variable geometry turbine (VGT). The position of the bypass valve or VGT may be adjusted in order to alter the charge flow rate. The EGR may take the exhaust gas from an exhaust manifold and feed it to an intake manifold, where the exhaust gas is mixed with the fresh air supplied by the turbo charger. The EGR can decrease the oxygen concentration of the aspirated gas mixture. Meanwhile, the thermal mass of the cylinder content may be increased and thus the combustion temperature may be reduced. Since high combustion temperature and high oxygen concentration may result in high production of NOx, the use of EGR may decrease the NOx emission. The EGR may be controlled by a valve and/or a throttle via commands from the controller 210, which can be adjusted in order to alter the flow rate of the exhaust gas mixed with the fresh air.

The controller 210 is coupled to various systems and components to control operation of the vehicle and various vehicle systems 250, such as the transmission 258, the fuel system 310, the air handling system 320 or components thereof, etc. in order to, for example, control vehicle (e.g., vehicle speed) while meeting desirable operating parameters (e.g., NOx emissions goals, fuel consumption rates, etc.).

The controller 210 may be structured as one or more electronic control units (ECU). The controller 210 may be separate from or included with at least one of a transmission control unit, an exhaust aftertreatment control unit, a powertrain control module, an engine control module, or other vehicle controllers. In one embodiment, the components of the controller 210 are combined into a single unit. In another embodiment, one or more of the components may be geographically dispersed throughout the system or vehicle. In this regard, various components of the controller 210, discussed below, may be dispersed in separate physical locations of the vehicle 100.

As shown, the controller 210 includes a processing circuit 215 having a processor 220 and a memory device 225, an optimizer circuit 212, an air-handling model circuit 235, a cylinder and combustion model circuit 240, a sensor circuit 245, and a communications interface 315. The communications interface 315 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and (in some embodiments, such as if a telematics unit is not included) out-of-vehicle communications (e.g., with a remote server). For example and regarding out-of-vehicle/system communications, the communications interface 315 may include an Ethernet card and port for sending and receiving data via an Ethernet-based communications network and/or a Wi-Fi transceiver for communicating via a wireless communications network. The communications interface 315 may be structured to communicate via local area networks or wide area networks (e.g., the Internet) and may use a variety of communications protocols (e.g., IP, LON, Bluetooth, ZigBee, radio, cellular, near field communication). Furthermore, the communications interface 315 may work together or in tandem with a telematics unit in order to communicate with other vehicles in the fleet of one or more vehicles. As alluded to above, the controller 210 is configured to control one or more vehicle systems 250 based on a control-oriented model. As the controller 210 continues to run or execute processes described herein, the control of the vehicle system 250 is improved over time.

In one embodiment, the optimizer circuit 212, the air-handling model circuit 235, the cylinder and combustion model circuit 240, and the sensor circuit 245 are embodied as machine or computer-readable media storing instructions that are executable by a processor, such as processor 220. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple processors. In the latter scenario, the remote processors may be connected to each other through any type of network (e.g., CAN bus, etc.).

In another embodiment, the optimizer circuit 212, the air-handling model circuit 235, the cylinder and combustion model circuit 240, and the sensor circuit 245 are embodied as hardware units, such as electronic control units. As such, the optimizer circuit 212, the air-handling model circuit 235, the cylinder and combustion model circuit 240, and the sensor circuit 245 may be embodied as one or more circuitry components including, but not limited to, processing circuitry, network interfaces, peripheral devices, input devices, output devices, sensors, etc. In some embodiments, the optimizer circuit 212, the air-handling model circuit 235, the cylinder and combustion model circuit 240, and the sensor circuit 245 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the optimizer circuit 212, the air-handling model circuit 235, the cylinder and combustion model circuit 240, and the sensor circuit 245 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The optimizer circuit 212, the air-handling model circuit 235, the cylinder and combustion model circuit 240, and the sensor circuit 245 may also include programmable hardware devices such as field programmable gate arrays, programmable array logic, programmable logic devices or the like. The optimizer circuit 212, the air-handling model circuit 235, the cylinder and combustion model circuit 240, and the sensor circuit 245 may include one or more memory devices for storing instructions that are executable by the processor(s) of the optimizer circuit 212, the air-handling model circuit 235, the cylinder and combustion model circuit 240, and the sensor circuit 245. The one or more memory devices and processor(s) may have the same definition as provided below with respect to the memory device 225 and processor 220. In some hardware unit configurations and as described above, the optimizer circuit 212, the air-handling model circuit 235, the cylinder and combustion model circuit 240, and the sensor circuit 245 may be geographically dispersed throughout separate locations in the vehicle. Alternatively and as shown, the optimizer circuit 212, the air-handling model circuit 235, the cylinder and combustion model circuit 240, and the sensor circuit 245 may be embodied in or within a single unit/housing, which is shown as the controller 210.

In the example shown, the controller 210 includes a processing circuit 215 having a processor 220 and a memory device 225. The processing circuit 215 may be configured to execute or implant the instructions, commands, and/or control processes described herein with respect to the optimizer circuit 212, the air-handling model circuit 235, the cylinder and combustion model circuit 240, and the sensor circuit 245. The depicted configuration represents the optimizer circuit 212, the air-handling model circuit 235, the cylinder and combustion model circuit 240, and the sensor circuit 245 as machine or computer-readable media. However, as mentioned above, this illustration is not meant to be limiting as the present disclosure contemplates other embodiments where the optimizer circuit 212, the air-handling model circuit 235, the cylinder and combustion model circuit 240, and the sensor circuit 245, or at least one circuit of the optimizer circuit 212, the air-handling model circuit 235, the cylinder and combustion model circuit 240, and the sensor circuit 245, is configured as a hardware unit. All such combinations and variations are intended to fall within the scope of the present disclosure.

The processor 220 may be implemented as one or more processors, one or more application specific integrated circuits (ASIC), one or more field programmable gate arrays (FPGAs), a digital signal processor (DSP), a group of processing components, or other suitable electronic processing components. The one or more processors may be shared by multiple circuits (e.g., the optimizer circuit 212, the air-handling model circuit 235, the cylinder and combustion model circuit 240, and the sensor circuit 245 may comprise or otherwise share the same processor which, in some example embodiments, may execute instructions stored, or otherwise accessed, via different areas of memory). Alternatively or additionally, the one or more processors may be configured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory device 225 (e.g., RAM, ROM, Flash Memory, hard disk storage, etc.) may store data and/or computer code for facilitating the various processes described herein. The memory device 225 may be communicably coupled to the processor 220 to provide computer code or instructions to the processor 220 for executing at least some of the processes described herein. Moreover, the memory device 225 may be or include tangible, non-transient volatile memory or non-volatile memory. Accordingly, the memory device 225 may include database components, object code components, script components, or any other type of information structure for supporting the various activities and information structures described herein.

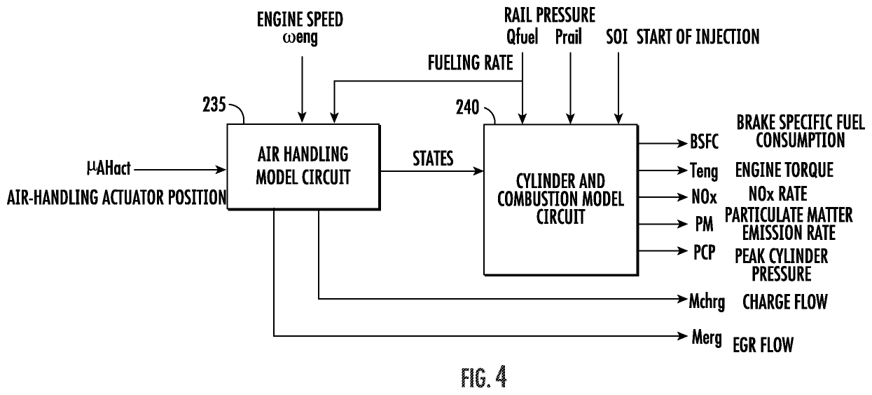

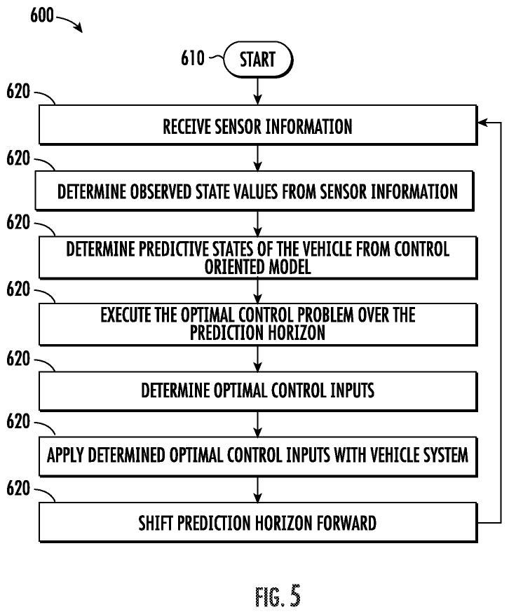

The optimizer circuit 212 is configured to communicate with the memory device 225 to execute, run, determine, and/or otherwise solve an optimal control problem. As described herein, the “optimal control problem” (also referred to as a “control problem”) refers to a cost function that is minimized based on a predictive state of the vehicle and subject to one or more constraints with the objective of meeting one or more vehicle, vehicle system, and/or vehicle component performance goals (e.g., minimizing fuel usage, increasing fuel efficiency, etc.). The cost function is shown as J(u) herein. The optimizer circuit 212 is structured to solve the “optimal control problem” in order to determine optimal control inputs for one or more systems and/or components within the vehicle system 250 at each time step, k, over a prediction horizon. The process for solving the optimal control problem may be referred herein as an “optimization process” herein. The “prediction horizon” is an interval, namely a time interval in the future relative to an instant point in time, that can be any of a variety of preset lengths of time (e.g., 10 milliseconds, 20 milliseconds, 20 seconds, 1 minute, 5 minutes, etc.). This length of time is denoted as Np in the cost function which is explained in more detail with respect to FIG. 4 herein. At each time step, k, the optimizer circuit 212 evaluates the cost function over the prediction horizon, and determines and communicates to the vehicle system 250 the control inputs for the time step, k. Subsequently, the optimizer circuit 212 shifts the prediction horizon forward one time step to begin the optimization process again. The optimization process is explained in more detail below with respect to FIG. 5.

As mentioned above, the optimizer circuit 212 evaluates the cost function subject to one or more constraints. The one or more “constraints” refer to system based constraints provided to the optimizer circuit 212 based on the defined or designated limits of the vehicle system 250 (e.g., maximum allowed engine torque/speed/power output, maximum allowed vehicle speed, and/or other maximum/minimum allowed ranges of components/vehicle systems) and/or allowable thresholds, such as environmental factors, associated with operation the vehicle 100 (e.g., allowable emissions, allowable engine noise, allowable engine braking etc.). In some embodiments, the system based constraints may be set by management personnel (e.g., a fleet operator remotely via the network such that the fleet operator/manager computing system is the remote information source), the user/operator of the vehicle 100, or another entity (e.g., another vehicle, another user, etc.). Additionally, one or more of these constraints may be received by the optimizer circuit 212 from the remote information source 270. For example, certain jurisdictions may have exhaust emission standards, rules, and/or regulations related to vehicles operating within the jurisdiction. Management personnel, such as fleet operators, may keep a route information database that stores these jurisdiction specific rules and regulations as environmental constraints (i.e., allowable thresholds for environmental factors associated with the vehicle). When a driver within a fleet enters such a jurisdiction as evidenced by a GPS signal, the optimizer circuit 212 may receive the jurisdiction specific environmental constraints from a remote information source (i.e., the route information database). Jurisdiction specific environmental constraints may define a maximum allowed NOx amount in a certain jurisdiction, a maximum allowed particulate matter amount in a certain jurisdiction, a maximum allowed engine noise, whether engine braking is allowed or not, etc. (it should be understood that “maximum” may be substituted for minimum or another desired parameter in other embodiments). In operation, the constraints may define the range of possible values for operating/controlling vehicle systems/components 250. Thus, the “constraints” may be a range of permitted actuator values for certain conditions given the allowable maximum (or minimum) within a particular jurisdiction.

The optimizer circuit 212 may be coupled to sensor circuit 245 and receive information therefrom (e.g., “sensor inputs”). The sensor circuit 245 is coupled to the sensors of the vehicle 100 (e.g., sensor array, etc.). In some embodiments, the sensor inputs may be measurement values or state values associated with a vehicle system 250. Sensor inputs may include, but are not limited to, information indicative of a temperature, a pressure, an engine speed, an engine torque, an exhaust emission output (e.g., greenhouse gases, CO, NOx, particulate matter, etc.), and any other parameter determined or measured by a sensor in the vehicle 100. In some embodiments, the optimizer circuit 212 determines control inputs by solving the optimal control problem based on the control-oriented model stored within memory device 228.

As mentioned above, the optimizer circuit 212 solves an optimal control problem (e.g., minimizes a cost function, J(u), to achieve a predictive state for the vehicle subject to the constraints described above) in order to determine control inputs for the vehicle system 250. The control inputs are then implemented with the vehicle system 250. Control inputs refer to commands, signals, one or more values, instructions, a combination thereof, etc. that control operation of one or more systems or components of the vehicle system 250 (e.g., engine, fuel system, transmission, air-handling system, aftertreatment system, etc.). Control inputs are communicated to the vehicle system 250 through the communication interface 315 in order to control operation of the vehicle system/component. For example, once the optimizer circuit 212 has solved the optimal control problem and determined a fueling rate (i.e., a control input) that is predicted to minimize the cost function, the controller 210 may command the fuel system 310 to adjust a fueling amount for an engine cycle for a given period of time (e.g., for the next 20, 30 or 60 seconds) in order to hit the fueling rate. At the end of this given period of time, the optimizer circuit 212 may compare the actual fueling rate as measured by a sensor to the control input fueling rate to determine if the cost function was minimized as predicted by the control-oriented model 228. The control-oriented model 228 may then be updated based on this comparison so that it can more accurately predict the vehicle's behavior (in this case with respect to fueling rate) in the future.

The optimizer circuit 212 is communicably coupled to the air-handling model circuit 235 and cylinder and combustion model circuit 240 and receives predictive states of the vehicle system 250 from the air-handling model circuit 235 and the cylinder and combustion model circuit 240 which are used to solve the optimal control problem. The predictive states are determined based on the control-oriented model 228. For example, the air-handling model circuit 235 and the cylinder and combustion model circuit 240 may determine that if an acceleration pedal is depressed 30% relative to its resting position that will lead to an engine torque increasing by 30%. In some embodiments, the air-handling model circuit may include a physics based model including one or more differential equations or any other functions that may be used to model the behavior of the air-handling portion of the vehicle. For example, the differential equation may take the form of: dy/dx=Ax+By+C. Though the differential equation shown here is a first order linear differential equation, the differential equation may be any other order and/or non-linear. For example, in “Modelling Diesel Engines with a Variable-Geometry Turbocharger and Exhaust Gas Recirculation by Optimization of Model Parameters for Capturing Non-Linear Systems Dynamics” by Wahlstrom et. al, which is incorporated herein by reference in its entirety, many equations that model performance of a diesel engine system are shown. It should be noted that the equations described in this publication are only meant to be exemplary and the air-handling model circuit 235 (and controller 210 generally) may include one or more equations described in the above publication or completely different equations not described therein that define, at least in part, the control oriented model.

In some embodiments, the combustion model circuit 240 may include a machine learning based model that uses one or more algorithms to predict outcomes from data provided to the machine learning system. More specifically, the cylinder and combustion model may utilize a neural network in which a number of inputs (e.g., text, numbers, images, sounds, etc.) are put into a hidden layer of the neural network which manipulates the input according to a number of mathematical models in order to provide a predictive output. The hidden layer of the neural network is capable of learning patterns based on the input received and therefore gets better at predicting outcomes as more input data is put into the neural network.

The air-handling model circuit 235 and the cylinder and combustion model circuit 240 may then use look up tables, equations, and/or algorithms (or other processes) within the control-oriented model 228 to determine a predictive state of the vehicle based on predicting that the engine torque will increase by a predefined amount when the acceleration pedal is depressed a predefined amount. The predictive states of the vehicle may include one or more outputs that describe the predictive state of the vehicle (e.g., BSFC, engine torque, NOₓ rate, particulate matter emission rate, peak cylinder pressure, charge flow, and EGR flow). Thus, the predictive states, and same as the control inputs, may be represented as matrices for execution by the controller. Accordingly, there may be multiple predictive states for multiple control inputs (i.e., not a one-to-one relationship). The optimizer circuit 212 may use the predictive states provided by the air-handling model circuit 235 and the cylinder and combustion model circuit 240 to solve the optimal control problem (i.e., minimizing a cost function subject to the system based constraints) by determining what the outputs of minimizing the cost function will be based on the predictive states provided by the control oriented model 228. Solving the optimal control problem will determine control inputs that are to be implemented within the vehicle system 250.

As mentioned above, the air-handling model circuit 235 is configured or structured to provide predictive states to the optimizer circuit 212 based on an air-handling model stored within the memory device 225. The air-handling model circuit 235 may be communicably coupled to sensor circuit 245 and receive information therefrom in the form of sensor inputs as well. The sensor inputs may be used to determine states of the vehicle system. The state values (e.g., exhaust manifold pressure (P_{EM}), an intake manifold pressure (P_{IM}), a turbine speed (ω_{T}), an intake manifold temperature (T_{IM}), and an exhaust manifold temperature (T_{EM})) are internal to the air-handling model and can change dynamically as the air-handling model updates and changes. The air-handling model circuit 235 may be coupled to the optimizer circuit 212 and the optimizer circuit 212 may provide control inputs (e.g., u_{AHact}) to the air-handling model circuit 235 to further develop the model as explained in more detail below.

In some embodiments, the cylinder and combustion model circuit 240 is configured to provide predictive states to the optimizer circuit 212 based on a cylinder and combustion model stored within the memory device 225 (or, stored with the circuit 212 itself in some embodiments). The cylinder and combustion model circuit 240 is coupled to sensor circuit 245 and receives sensor inputs as well. In some embodiments, these sensor inputs may be state values associated with the vehicle. In some embodiments, the cylinder and combustion model circuit 240 is coupled to the optimizer circuit 212 and the optimizer circuit may provide control inputs (e.g., Q_{fuel}, Pᵣₐᵢₗ, and SOI) to the cylinder and combustion model circuit 240 to further develop the model as explained in more detail in the following paragraphs.

The sensor circuit 245 is configured to receive and process sensor information received from one or more sensors within the sensor array 260. In some embodiments, the sensor circuit 245 includes one or more virtual sensors arranged to determine operational parameters based on one or more related sensor signals. The sensor circuit may also be coupled to physical sensors. A virtual sensor refers to the utilization of one or more processes to determine a measurement of a value without an actual sensor reading for that particular value. For example, a virtual sensor may measure a value using mathematical methods and/or other methods (e.g., look-up tables, models, formulas, etc.). The sensor circuit may measure temperature readings, pressure readings, and emission output readings within the vehicle system 250. The sensor circuit 245 communicates with the optimizer circuit 212, the air-handling model circuit 235, and the cylinder and combustion model circuit 240.

The memory is shown to include a control-oriented model 228. The control-oriented model is a mathematical and, in particular as shown, a machine learning model that is the basis for determining predictive states within the air handling model circuit 235 and the cylinder and combustion model circuit 240. In this example, the control-oriented model is made up of two parts: an air-handling model and a cylinder and combustion model which are described in more detail below. The integration of the control-oriented model 228 within the controller 210 allows the controller 210 to improve performance for a vehicle that may result in, for example, lower emissions, better fuel economy, more torque, more stable speed control with the cruise control system, more efficient use of the aftertreatment system, increased longevity of the engine or transmission, etc. In some embodiments, the controller 210 is able to tune the engine, transmission, or another vehicle system or component continually and in real time so that performance of the vehicle system is maintained and improved over time. Traditional vehicle systems only include tuning at initial commissioning or at spaced apart service intervals. Therefore, the controller 210 provides a significant advantage over systems that rely on human interaction to tune or update the control-oriented model of the vehicle system. Continued updating of the control-oriented model allows the vehicle system to achieve improved performance over the life of the vehicle system when compared with traditional systems that do not utilize machine learning techniques. For example, as vehicle systems age, age information can be used to update the control-oriented model and provide improved performance over the life of the vehicle or vehicle system as the performance characteristics of the vehicle or vehicle system change with age.

The controller 210 utilizes model predictive control to control a vehicle system in view of look-ahead or horizon information so that the controller 210 accounts for future conditions (e.g., on a roadway) that can include altitude, road grade, speed limit changes, traffic, road construction, etc. Additionally, fleet information can be used to update the control-oriented model 228 such that a first vehicle can benefit from the experiences of a second vehicle over time. The control-oriented model 228 of the first vehicle can be updated in view of information collected by the second vehicle. For example, the control-oriented model 228 of the first vehicle can be updated over time based on the aging experience of the second older vehicle. In this way, the control-oriented model 228 of the first vehicle can account for aging components over time to maintain an improved vehicle operation. As another example, the observed states or predicted states of a second model for a set of control inputs may be transmitted and used by the controller 210 to avoid executing the optimal control problem and working to optimize the model faster and more efficiently (e.g., less computing power). These and other embodiments of the controller 210 allow for improved operation and tuning via an updating the control-oriented model 228. Systems that are reliant on static tuning at discrete time intervals are not able to provide improved operation over time or operation that adapts to changing environments, and/or fleet interaction.

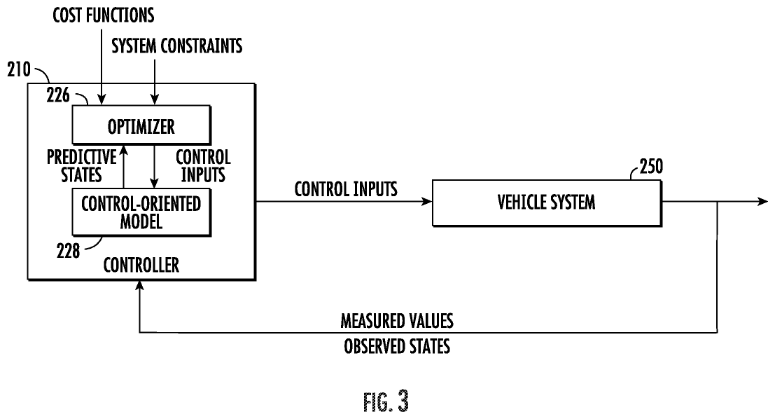

Referring now to FIG. 3, flow diagram showing inputs to a controller and outputs from the controller 210 to the vehicle system 250 is shown, according to an example embodiment. The controller 210 may be configured to provide control inputs to the vehicle system 250. As mentioned above, these “control inputs” refer to control commands, signals, etc. that control operation of one or more systems or components of the vehicle system 250. For example, the control inputs may include, but are not limited to, a fuel injection quantity (IQ), a start of injection (SOI), a rail pressure (Pᵣₐᵢₗ), a charge flow (M_{chrg}), fueling (Q_{fuel}), air-handling actuator position (u_{AHact}), an exhaust gas recirculation flow (M_{egr}), and so on. The controller 210 is configured to optimize the control inputs over time by solving an optimal control problem based on one or more constraints. The optimal control problem includes a cost function, J(u), that is optimized and particularly, minimized, subject to the one or more constraints over a prediction horizon. The cost function, J(u), includes minimizing fuel usage while simultaneously minimizing costs related to emissions over the duration of a control window.

As alluded to above, the optimizer circuit 212 is configured to optimize the control inputs by minimizing the cost function J(u). As mentioned above, the optimizer circuit 212 minimizes the cost function J(u) over the duration of the prediction horizon. In one embodiment, the cost optimization performed by the optimizer circuit 212 can be expressed as:

$${arg min}_{u} J ( u )$$

Where J(u) is defined as follows:

$$J ( u ) = {\sum }_{k = 1}^{{N}_{p} + 1} {Q}_{fuel} + {w}_{1} {\dot{NO}}_{x}^{2} + {w}_{2} {\dot{PM}}^{2}$$

The first term in the cost function represents the fuel consumption that the optimizer aims to minimize. In some embodiments, the first term in the cost function may be associated with a break specific fuel consumption (BSFC) and may be re-written as follows:

$$J ( u ) = {\sum }_{k = 1}^{{N}_{p} + 1} BSFC + {w}_{1} {\dot{NO}}_{x}^{2} + {w}_{2} {\dot{PM}}^{2}$$

The second and third term in the cost function represents costs related to emissions. In other embodiments, the cost function may not include the second and third terms. It is to be understood that the above cost functions are meant to be exemplary and not limiting in nature. The cost function may have any one or more terms (i.e., parameters) to be optimized associated with the vehicle system 250. For example, the cost function may include terms such as the engine torque (Teng), charge flow (M_{chrg}), EGR flow (M_{egr}), and peak cylinder pressure (PCP). In some embodiments, the cost function can use weighting variables w₁ and w₂ to designate how importantly (much or little) to weigh different emissions parameters and their related costs. In operation and as an example, the costs related to emissions include exhaust gas constituent emission parameters (e.g., NOx and PM), and the cost function aims to minimize the exhaust gas constituent emission parameters. In the cost function shown above, NOₓ represents the NOx emissions rate and PM represents the particular matter emission rate.

In some embodiments, the controller optimizes the cost function J(u) subject to one or more constraints which, when applied by the controller 210, ensure or likely ensure that acceptable control inputs are provided to the vehicle system. In this instance, “acceptable” refers to control inputs that are possible for various given conditions (e.g., a requested torque amount cannot exceed a maximum allowed engine torque such that a constraint includes a maximum allowed engine torque). The constraints may be static or dynamic in nature (e.g., updated over time). Further, one or more constraints may be absolute (e.g., a maximum allowed engine torque) or change based on various operating conditions (e.g., a maximum allowed engine speed may differ for various transmission settings or other conditions, such as altitude conditions). For example, if the optimizer circuit 212 solves the optimal control problem and determines an engine torque control input that would command the vehicle system to implement an engine torque higher than the allowed engine torque, the vehicle 100 may experience system failure. Therefore, the optimizer circuit 212 constrains an engine torque control input so that the engine my function properly. In some embodiments, the cost function J(u) may be subject to the constraint that the engine torque must be greater than or equal to the desired torque. In some embodiments, the cost function J(u) may also be subject to range limit constraints on air-handling actuators position, charge and EGR flows, turbine speed, exhaust temperature, etc.

As mentioned above, the controller 210 includes the control-oriented model 228 which is configured to be retrieved from the memory 225 and processed and/or executed by the processor 220 to provide predictive states to optimizer circuit 212 based on the predictive nature of the control-oriented model 228. The control-oriented model 228 may have the form:

$$x ( k + 1 ) = Ax ( k ) + Bu ( k )$$

where x(k) is the state vector, u(k) is the control input vector, and A and B are the model parameters (e.g., predefined constants). In this example, the control-oriented model is linear but, in other embodiments, the model may take a non-linear form. The state vector, which holds the states of the vehicle, may include but is not limited to an exhaust manifold pressure (P_{EM}), an intake manifold pressure (P_{IM}), a turbine speed (ω_{T}), an intake manifold temperature (T_{IM}), and an exhaust manifold temperature (T_{EM}). As can be seen from the function above, the control-oriented model predicts the future states of the vehicle at x(k+1) based on the current state, x(k), and the current control inputs, u(k), of the vehicle system. The control-oriented model also includes coefficients A and B which are model parameters. Model parameters can be determined in a variety of ways. For example, management personnel may develop model parameters based on vehicle characteristics, vehicle experiments, and other data associated with the vehicle 100 or other vehicles similar to the vehicle 100. In some embodiments, A and B are provided to optimizer circuit 212. Additionally, the control-oriented model 228 may provide the predicted state, x(k+1), as a constraint to the optimizer circuit 212. It is to be noted that the control-oriented model may have various forms (e.g., non-linear etc.) and that the form of the control-oriented model described herein is only meant to be exemplary. In some embodiments, the control oriented model 228 may be a dynamic model which is continuously updated based on data collected regarding the vehicle.

In some embodiments, the controller 210 sends control inputs to the vehicle system 250 based on the controller 210 solving or determining the optimal control problem and determining the control inputs for the current state or time step (e.g., x(k)). Via one or more physical or virtual sensors, the vehicle system 250 outputs or provides the current state of the vehicle back to controller 210 based on the previously provided control inputs so that the controller 210 can repeat the process at the next time step.

Referring now to FIG. 4, another block diagram illustrating the inputs and outputs to and from the air-handling model circuit 235 and the cylinder and combustion model circuit 240 are shown in greater detail, according to an example embodiment. FIG. 4 depicts the model predictive control strategy of the controller 210 being employed with an air handling system of vehicle and a cylinder and combustion system of the vehicle. Similar principles and methods may be employed/utilized with other vehicle systems.

As mentioned above, the air handling model circuit 235 and the cylinder and combustion model circuit 240 provide predictive states to the optimizer circuit 212 based on the control-oriented model 228 which, in this example, includes an air-path model and a cylinder and combustion model processed by the air handling model circuit 235 and cylinder and combustion model circuit 240 respectively. In other embodiments, these models may be stored by the memory of the controller 210. The control-oriented model may be comprised of look-up tables, algorithms, and/or formulas executable by the processing circuit 215. In one embodiment, the air-path model and the cylinder and combustion model are each stored within the memory device 225, and the air path model and the cylinder and combustion model are each executable and processed through the air-handling model circuit 235 and the cylinder and combustion model circuit 240, respectively. In some embodiments, air-handling model circuit 235 is configured to provide predictive states associated with the air-handling system 320 of the vehicle. For example, the air-handling model circuit 235 may be configured to control the amount of gas flowing through an aftertreatment system. In some embodiments, the air-path model may be a physics-based model (i.e., a model developed based on Newtonian physics) and may be configured to use sensor information from sensor array 260 to develop the air-path model. For example, the air-handling model circuit 235 may receive the air-handling actuator position (u_{AHact}) and ω_{eng} from sensor array 260. In some embodiments, the air-handling model circuit 235 outputs M_{chrg} and M_{egr} based on solving the optimal control problem within the optimizer circuit 212 by the controller 210.

As explained above, the control-oriented model 228 includes a cylinder and combustion model which is processed and executable by the cylinder and combustion model circuit 240. In some embodiments, the cylinder and combustion model is configured to provide predictive states associated with the cylinder and combustion portion of the vehicle. In some embodiments, the cylinder and combustion model may include or be based on neural networks. In some embodiments, the cylinder and combustion model circuit 240 may receive one or more inputs and provide one or more outputs. For example, the cylinder and combustion model circuit 240 may receive control inputs Q_{fuel}, Pᵣₐᵢₗ, and SOI, and generate predictive values BSFC, T_{eng}, NOₓ, PM, and PCP based on the constraints to the optimal control problem solved by the optimizer circuit 212.

Referring now to FIG. 5, a method 600 for determining and implementing control inputs for a vehicle and particularly vehicle system or component, is shown according to an example embodiment. The method 600 may be performed by the controller 210 such that reference may be made to the controller 210 and vehicle 100 to aid explanation of the method 600.

The method 600 starts at step 610 when the vehicle begins operation. In one embodiment, vehicle operation is associated with the engine starting. In another embodiment, vehicle operation is associated with a different parameter (e.g., a button depressed by an operator, an ignition key turned by an operator, after a predefined run time or cycles of an engine of the vehicle, etc.). Initiation corresponds with a time step k=0. As soon as operation begins, which in this embodiment is when the engine begins to run, the controller 210 may retrieve initial models, constraints, and control inputs that allow the vehicle to begin running at time step k=0. These initial models, constraints, and control inputs may be best guess models, constraints, and control inputs designed to control the vehicle system 250 and components. In other words, the initial operating parameters may be from a manufacturer and only initially tuned. Thus, in this case, this is the first non-manufacturer vehicle operation. While the control models employed by the manufacturer are typically complex and well-designed, they are also typically static in nature. The predictive control employed herein enables a dynamically changing control strategy for the controller 210 to dynamically control the vehicle and vehicle system/components in an ever-changing manner over time.

At step 620, the controller 210 receives sensor information from sensor array 260. This sensor information may include, but is not limited to, u_{AHact}, ω_{eng}, a NOₓ gas output level, a PM output level, an engine speed, etc. At step 630, the controller 210 determines observed state values based on the sensor information received at step 620. The states of the vehicle may include, but are not limited to, emissions rates, engine speed, desired torque, P_{EM}, P_{IM}, ω_{T}, T_{IM}, and T_{EM}. These state values may be the sensor values or determines values regarding operation of the system/component.

At step 640, the controller 210 determines predictive states of the vehicle based on the control-oriented model 228. As explained above, the control-oriented model is predictive in nature. The control-oriented model uses the current control inputs and observed state values, in addition to certain model parameters A and B, to predict the next state of the vehicle. Once this next state has been predicted, the control-oriented model outputs one or more predicted states (e.g., BSFC, T_{eng}, M_{chrg}, M_{egr}, NOₓ, PM, and PCP) of the vehicle in addition to model parameters A and B to the optimizer 212. As mentioned above, the control oriented model 228 may have the form:

$$x ( k + 1 ) = Ax ( k ) + Bu ( k )$$

At step 650, the optimizer circuit 212 solves the optimal control problem over the prediction horizon. In order to solve the optimal control problem over the prediction horizon, the optimizer circuit 212 receives a predictive state of a vehicle from the air handling model circuit 235 and the cylinder and combustion model circuit 240. Then given the predictive state of the vehicle system 250, the optimizer will minimize the cost function in order to achieve the predictive state of the vehicle system 250 subject to one or more constraints. As mentioned above, the one or more “constraints” refer to system based constraints provided to the optimizer circuit 212 based on the defined or designated limits of the vehicle system 250 (e.g., maximum allowed engine torque/speed/power output, maximum allowed vehicle speed, and/or other maximum/minimum allowed ranges of components/vehicle systems) and/or allowable thresholds, such as for environmental factors, associated with operation the vehicle 100 (e.g., allowable emissions, allowable engine noise, allowable engine braking etc.). The system based constraints may be set by management personnel (e.g., a fleet operator remotely via the network such that the fleet operator/manager computing system is the remote information source), the user/operator of the vehicle 100, or another entity (e.g., another vehicle, another user, etc.). For example and in regard to system-based constraints, the vehicle system 250 may have constraints related to engine torque or actuator positions (e.g., maximum allowed engine torque, maximum allowed actuator positions, etc.). Furthermore, a constraint regarding a maximum allowed engine torque output may be set to ensure the optimizer circuit 212 does not provide control inputs to the vehicle that cause the engine to exceed this maximum allowed torque output amount. In another example, an actuator may only be able to take a position within certain limits so a constraint may be set in order to limit the actuator position. Additionally, the optimizer circuit 212 may receive or retrieve predictive states from the control-oriented model 228 as explained above. The controller 210 solves the optimal control problem based on one or more constraints and the predictive states to, in this example, minimize certain variables (e.g., BSFC, NOₓ, PM, and/or Q_{fuel}) (which may be “maximize” or a different metric in a different embodiment) based on the optimization objective such as meeting one or more vehicle, vehicle system, and/or vehicle component performance goals (e.g., minimizing fuel usage, increasing fuel efficiency, etc.).

At step 660, the optimizer circuit 212 of the controller 210 determines the control inputs (e.g., Q_{fuel}, Pᵣₐᵢₗ, u_{AHact}, SOI, M_{chrg}, M_{egr}, etc.) based on the results of solving the optimal control problem at step 650. At step 670, the controller 210 implements the control inputs determined at step 660 with vehicle 100. Implementing the control inputs may include commanding control of various vehicle component (e.g., a start of injection with at least one cylinder of an engine, a fuel flow rate, or a rail pressure for a common rail coupled to at least one fuel injector of the vehicle). At step 680, the controller 210 completes the first iteration of predictive control at time step k=1. At step 680, the prediction horizon shifts forward one time step to k=2, then the method 600 begins again at the next time step. The method 600 continues to repeat over and over again as long as the vehicles continues to run.

| As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 210 may include any number of circuits for completing the functions described herein. For example, the optimizer circuit 212, the air-handling model circuit 235, the cylinder and combustion model circuit 240, and the sensor circuit 245 may be combined in multiple circuits or as a single circuit. Additional circuits with additional functionality may also be included. Further, the controller 210 may further control other activity beyond the scope of the present disclosure.

As mentioned above and in one configuration, the “circuits” may be implemented in machine-readable medium for execution by various types of processors, such as the processor 220 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system, comprising:
a processing circuit comprising one or more memory devices coupled to one or more processors, the one or more memory devices configured to store instructions that, when executed by the one or more processors, cause the processing circuit to:
receive information indicative of an observed state of a vehicle system of a vehicle from a sensor of the vehicle, the vehicle system including a fuel system;
determine a predictive state of the vehicle system over a prediction horizon;
determine one or more constraints for the vehicle system;
execute a control problem to determine a predictive state of the vehicle system based on the one or more constraints for the vehicle system over the prediction horizon;
determine a plurality of control inputs for the vehicle system based on the executed control problem; and
command the fuel system of the vehicle based on at least one of the determined plurality of control inputs, the command structured to control at least one of a start of injection with at least one cylinder of an engine, a fuel flow rate, or a rail pressure for a common rail coupled to at least one fuel injector of the vehicle.

2. The system of claim 1, wherein the instructions, when executed by the one or more processors, further cause the processing circuit to:
compare sensor information received after controlling operation of the vehicle system according to the at least one of the determined plurality of control inputs relative to a desired set point;
update a control-oriented model in response to the comparison; and
control the vehicle system using the updated control-oriented model.

3. The system of claim 1, wherein executing the control problem includes minimizing a cost function that includes a fuel consumption variable and one or more emission variables.

4. The system of claim 1, wherein the one or more constraints includes at least one of a maximum allowed engine torque, a maximum allowed engine speed, a maximum allowed engine power output, or a maximum allowed vehicle speed.

5. The system of claim 1, wherein the vehicle system further includes an air handling system, wherein the instructions, when executed by the one or more processors, further cause the processing circuit to control operation of the air handling system based on at least one of the determined plurality of control inputs.

6. The system of claim 1, wherein the instructions, when executed by the one or more processors, further cause the processing circuit to:
receive fleet information from other vehicles; and
utilize the fleet information to update a control-oriented model.

7. An apparatus for a vehicle, comprising:
a processing circuit comprising one or more memory devices coupled to one or more processors, the one or more memory devices configured to store instructions that, when executed by the one or more processors, cause the processing circuit to:
receive information indicative of an observed state of a vehicle system from a sensor of the vehicle;
determine a predictive state of the vehicle system over a prediction horizon;
determine one or more constraints for the vehicle system;
execute a control problem to determine a predictive state of the vehicle system based on the one or more constraints for the vehicle system over the prediction horizon;
determine a control input for the vehicle system based on the executed control problem; and
command the vehicle system based on the determined control input.

8. The apparatus of claim 7, wherein the vehicle is a hybrid vehicle, and wherein the vehicle system includes an electric motor and an internal combustion engine, and wherein the control input defines a power split between the electric motor and the internal combustion engine.

9. The apparatus of claim 7, wherein the vehicle system comprises a natural gas engine.

10. The apparatus of claim 7, wherein the command to the vehicle system includes at least one of diverting energy to a battery of the vehicle or diverting energy to an electrically powered vehicle accessory.

11. The apparatus of claim 7, wherein the vehicle system comprises an air handling system, wherein the instructions, when executed by the one or more processors, further cause the processing circuit to control operation of the air handling system based on at least one of the determined plurality of control inputs.

12. The apparatus of claim 7, wherein the instructions, when executed by the one or more processors, further cause the processing circuit to:
compare sensor information received after controlling operation of the vehicle system according to the at least one of the determined plurality of control inputs relative to a desired set point;
update a control-oriented model in response to the comparison; and
control the vehicle system using the updated control-oriented model

13. The apparatus of claim 7, wherein the vehicle is an at least partially autonomous vehicle.

14. The apparatus of claim 13, wherein the instructions, when executed by the one or more processors, further cause the processing circuit to:
receive look ahead information and store the look ahead information in the one or more memory devices;
receive vehicle information regarding operation of the at least partially autonomous vehicle;
determine a speed target for the at least partially autonomous vehicle;
determine a fuel consumption target for the at least partially autonomous vehicle; and
command a fuel system and a powertrain of the at least partially autonomous vehicle to implement the speed target and the fuel consumption target.

15. A method comprising:
receiving, by one or more processors, information indicative of an observed state of a vehicle system of a vehicle from a sensor of the vehicle, the vehicle system including a fuel system;
determining, by the one or more processors, a predictive state of the vehicle system over a prediction horizon;
determining, by the one or more processors, one or more constraints for the vehicle system;
executing, by the one or more processors, a control problem to determine a predictive state of the vehicle system based on the one or more constraints for the vehicle system over the prediction horizon;
determining, by the one or more processors, a plurality of control inputs for the vehicle system based on the executed control problem; and
commanding, by the one or more processors, the fuel system of the vehicle based on at least one of the determined plurality of control inputs, the command structured to control at least one of a start of injection with at least one cylinder of an engine, a fuel flow rate, or a rail pressure for a common rail coupled to at least one fuel injector of the vehicle.

16. The method of claim 15, further comprising:
receiving, by the one or more processors, sensor information after controlling operation of the vehicle system according to the at least one of the determined plurality of control inputs;
updating, by the one or more processors, a control-oriented model based on the received sensor information after controlling operation of the vehicle system according to the at least one of the determined plurality of control inputs; and
controlling, by the one or more processors, the vehicle system using the updated control-oriented model.

17. The method of claim 15, wherein executing the control problem includes minimizing, by the one or more processors, a cost function that includes a fuel consumption variable and one or more emission variables.

18. The method of claim 15, wherein the one or more constraints includes at least one of a maximum allowed engine torque, a maximum allowed engine speed, a maximum allowed engine power output, or a maximum allowed vehicle speed.

19. The method of claim 15, wherein the vehicle system further includes an air handling system, the method further comprising controlling, by the one or more processors, operation of the air handling system based on at least one of the determined plurality of control inputs.

20. The method of claim 15, further compromising:
receiving, by the one or more processors, fleet information regarding other vehicles; and
utilizing, by the one or more processors, the fleet information to update a control-oriented model.
